(19) United States
(12) Patent Application Publication
(10) Pub. No.: US 2015/0278032 A1
(43) Pub. Date: Oct. 1, 2015

(54) PROVIDING SERVICES ON SYSTEM BEING RECOVERED

(71) Applicant: CA, Inc., Islandia, NY (US)

(72) Inventors: Alexey Shvechkov, Hopkinton, MA (US); Pratap Karonde, Holbrook, NY (US); Gil Zhao, Beijing (CN)

(73) Assignee: CA, Inc., Islandia, NY (US)

(21) Appl. No.: 14/231,904

(22) Filed: Apr. 1, 2014

(51) Int. Cl. G06F 11/14; G06F 9/455

(52) U.S. Cl. CPC G06F 11/1469; G06F 11/1435; G06F 11/1451; G06F 11/1441; G06F 9/45541; G06F 11/1484; G06F 2201/84; G06F 2201/815

(57) ABSTRACT

A method includes running a backup image of a device on the device while the device is being restored such that the device being restored is capable of servicing users while it is being restored. The method further includes determining if the data requested by an operating system image being executed is available from local storage of the device being restored, and causing the requested data to be stored in the local storage of the device being restored from a backup storage if the storage of the device being restored does not yet have the requested data.

### BACKGROUND

Bare Metal Recovery or Restore (BMR) is a technique where backed up data is available in a form which allows one to restore a computer system from “bare metal”, i.e. without any requirements as to previously installed software or operating system. BMR solutions typically assume that a server being recovered is not providing any services while recovery is in progress. At best, some solutions run a copy of the physical server inside a virtual machine (VM) to provide temporary services while the physical server gets restored and then administrators schedule down time to migrate recent changes from the VM to restored physical server. In most of the cases BMR means services down time.

### BRIEF SUMMARY

According to one aspect of the present disclosure, a method includes running a backup image of a device on the device while the device is being restored such that the device being restored is capable of providing service to users.

In another aspect, a system to be restored includes a local storage device and a processor. The processor is programmed to run a backup image such that the system is capable of responding to user requests directed to the system. The backup image may include an operating system that generates requests for data. The requested data may be retrieved from a backup storage and stored in the local storage of the system being restored if the local storage of the system being restored does not yet have the requested data.

In a further aspect, a computer program product includes a computer readable storage medium having computer readable program code embodied therewith. The computer program code includes computer readable program code configured to cause a processor to execute a backup image of a device being restored on the device being restored from bare metal, determine if needed data is available from local storage of the device being restored, and cause the needed data to be retrieved from a backup storage and stored in the local storage of the device being restored if the local storage of the device being restored does not yet have the needed data.

### BRIEF DESCRIPTION OF THE DRAWINGS

Aspects of the present disclosure are illustrated by way of example and are not limited by the accompanying figures with like references indicating like elements.

FIG. 1 is a block diagram illustrating a system responsive to requests during bare metal recovery of the system according to an example embodiment.

FIG. 2 is a flowchart illustrating a method of responding to requests during bare metal recovery of a system according to an example embodiment.

FIG. 3 is a block diagram illustrating an alternative system responsive to requests during bare metal recovery of the system according to an example embodiment.

FIG. 4 is a flowchart illustrating a method of responding to requests during bare metal recovery of a system booted with a backup image of the system stored on a remote storage device according to an example embodiment.

FIG. 5 is a block diagram of a computer system for implementing methods and algorithms according to example embodiments.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In various embodiments, a server that is being restored is booted using a backup image resided on a remote server. Initially, the server gets booted using initial boot loader code, which in turn loads the rest of an operating system. The data, including operating system code, will be read from a remote backup image that appears as a local boot device (as an iSCSI disk) or a virtual machine disk image to the server being restored. In one embodiment a remote server exposes the backup image via an iSCSI protocal allowing the server being restored to boot from an iSCSI target. In another embodiment, the remote backup image may appear as a virtual machine image that is run on a virtual machine on the server being restored.

While the server boots the operating system from a remote backup image via iSCSI (or when a virtual machine boots from remote backup image) data blocks are requested from backup image on demand. Data need not be copied/restored upfront. Requested data blocks that are not yet in a local storage device are obtained from remote backup image, used to populate the local storage device, and are also provided to a requesting entity, the operating system.

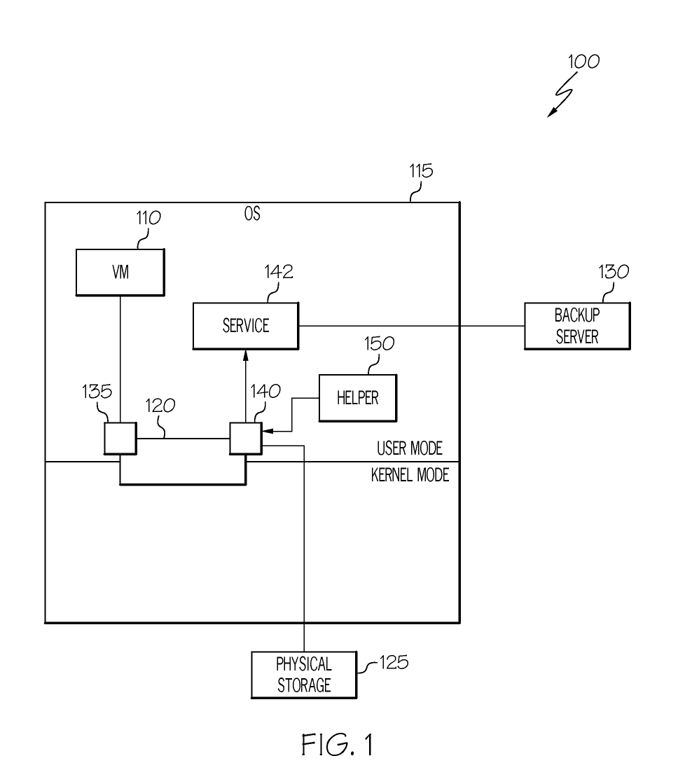

FIG. 1 is a block diagram which represents one embodiment where a system 100 responds to user requests during a recovery process. In this embodiment, during the bare metal recovery process on a physical server, a system backup image of the physical server is run inside a virtual machine 110, which in turn runs inside a bare metal recovery operating system 115. As a boot device, the virtual machine may use a pseudo block device 120 that may act as a proxy between a local physical disk 125 of the physical server being recovered, and remote storage 130 containing a backup of the physical server. In one embodiment, the pseudo block device 120 may be a software emulated device which may appear to the operating system as a disk device or as a file. In one example, a reparse point on a Windows operating system, which if accessed, may trigger execution of kernel and/or user mode drivers to fulfill an I/O request. A service 132 may be used to retrieve the data from backup server 130. The virtual machine 110 runs in a user mode.

When the virtual machine 110 accesses its virtual disk 135 via the pseudo block device 120, the pseudo block device checks if a block containing the requested data is present on the local physical disk 125. To determine if the block is present, the pseudo block device 120 may utilize a bitmap 140 showing blocks that have already been restored to the local physical disk 125 as part of the restore process and maintains mapping between blocks on local storage and offsets requested from pseudo block device 120. If a block is present because it has been restored, then it is read from local disk 125 directly and returned to the requestor, which is the virtual machine 110.

If the block is not present then pseudo block device 120 retrieves the block containing the requested data using user mode helper service 142 from remote storage 130 containing the backup, saves the block to the local physical disk 125, updates the bitmap 140 of restored blocks to indicate the block is now present in local storage 125, and returns the block to the requestor. The virtual machine 110 will also have a network interface that is configured to operate in bridged mode such that it shares the network interface with the hosting bare metal recovery operating system 115.

To provide services during the restore process, the virtual machine will be assigned with the same IP/host name previously owned by the physical server being restored and will provide the same service.

While the system being restored services user requests and runs operating system and application code, it gradually and on demand accesses data blocks from the backup image and effectively restores the data blocks to the local storage.

Based on the virtual machine performance, an additional background helper process 150 accessing blocks from the pseudo block device may be started. The helper process 150 may be used to access blocks which have not yet been retrieved or requested by the virtual machine. The helper process 150 may be a lower priority background process in some embodiments. The goal of the helper process 150 is to access all blocks which were not yet accessed or requested by the virtual machine.

After all blocks have been requested and accessed either by the virtual machine 110 or by the helper process 150, the bare metal recovery procedure is considered finished. At this stage (or at a time scheduled by administrator) the virtual machine is stopped. If necessary, drivers may get injected into the restored operating system on local storage, and the machine being recovered, also referred to as the server, may be rebooted into the restored operating system. Different drivers than those already restored may be injected where new or different hardware is used in the system being restored, or if newer drivers for hardware are available.

Restoring the backup image to the local storage 125 in real time while providing services via a virtual machine facilitates restoring a machine and at the same time avoids downtime.

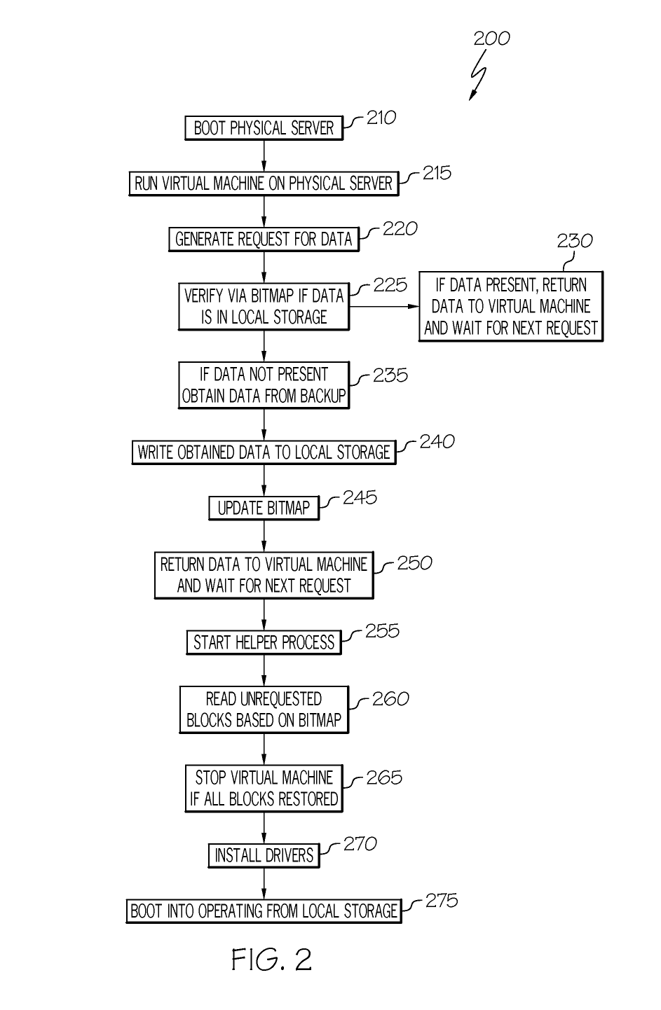

FIG. 2 is a flowchart illustrating a method 200 of providing services during bare metal recovery. To start bare metal recovery of a physical server, the physical server is booted at 210 via a BMR CD/DVD. In one example, the physical server is booted into a Linux based live CD by an administrator. An alternative is booting via PXE, Windows PE or other suitable software. The CD may contain prepackaged components and logic that are executed by the physical server.

A virtual machine is set up and run in user mode at 215. The virtual machine uses a user mode pseudo block device driver as its boot device. The virtual machine is started and configured via scripts prepackaged with BMR CD. The virtual machine's network interface should operate in bridged mode (where it shares the same physical NIC with host operating system).

When the virtual machine requests/reads disk block from virtual disk the request is made to the pseudo block device at 220. The virtual machine may initiate a request for data, which may arise during its normal operation on in response to servicing a user. The request for data may arise from a need to execute operating system code, application code, or otherwise access data not currently in local storage.

The pseudo block device driver maintains a bitmap of restored blocks. It may be assumed that the physical disk does not contain any data at the beginning The pseudo block device driver verifies at 225, using the bitmap or other construct operable to track blocks of data, whether the requested block was requested or read earlier by the virtual machine and was therefore already restored to local physical disk. If the data block is present on local storage then it is returned immediately at 230 to the virtual machine. Optimization and caching may also be utilized to increase efficiency and speed of responses in further embodiments.

If the requested data block was not previously restored or accessed, the pseudo block device driver's user mode service reads the data block from remote storage containing the backup image at 235, writes/restores block to local physical storage at 240, and updates the bitmap of restored blocks at 245. The pseudo block device driver then returns the data block to the virtual machine at 250.

While the virtual machine boots and provides services it will gradually request more and more blocks thus hydrating/restoring data from remote backup image to the local storage. However not all blocks may be accessed /requested by the virtual machine. To restore all blocks not yet requested by the virtual machine, a background user mode helper process may be started at 255. The helper process may read 260 all unrequested blocks as identified in the bitmap that is maintained by pseudo block device driver. In some embodiments, the pseudo block device driver may keep the bitmap in shared memory so that other user mode processes may use it.

After all blocks hydrated/restored to local storage, the virtual machine may be stopped at 265. Drivers for possibly dissimilar hardware may be injected at 270 to handle changed hardware. The physical server will then be booted at 275 into the operating system now stored on the local storage.

In further embodiments, method 200 may be implemented using Windows based tools. For example, similar logic may be implemented using WinPE and windows kmdf/umdf driver(s).

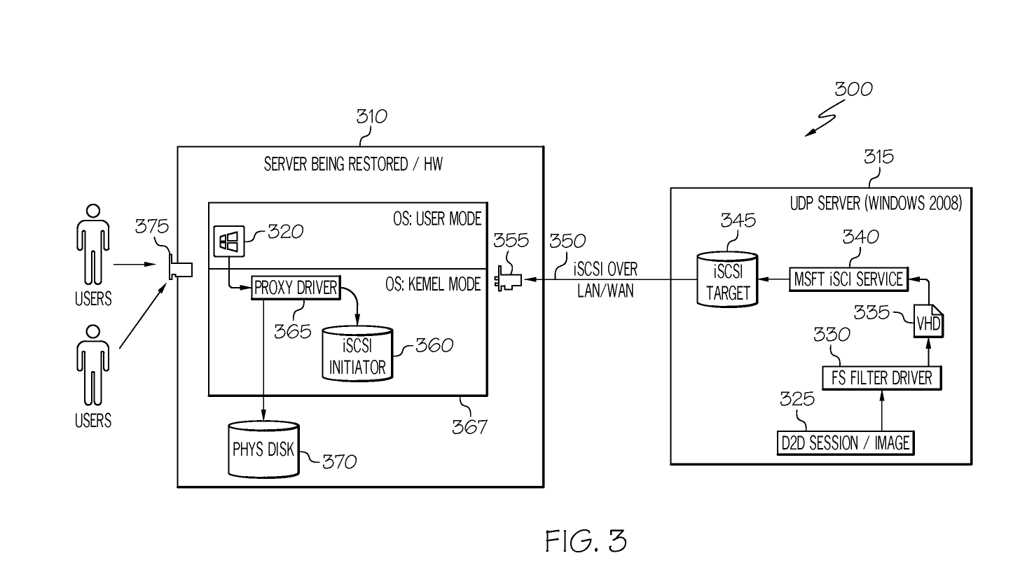

In another embodiment the server is booted from a remote backup image via iSCSI. The backup image is run directly on the server's hardware rather than inside a virtual machine. FIG. 3 is a block diagram of a system 300 that responds to user requests during a bare metal recovery process. During the bare metal recovery process on a physical server 310 being restored, a backup image of the server 310 is stored on a backup server 315 and made available to run on a processor 320 of the server 310 being restored. The backup image is used to boot the server 310 using an iSCSI protocol over a network for example. In one example, the backup image shown at 325 is exposed on remote server as a bootable iSCSI target device. In one embodiment, server 310 being restored uses an HBA card/PXE/gPXE for example, to boot from iSCSI target device, and runs the backup image 125 directly on server 310 hardware.

Before being exposed via iSCSI, the backup image 325 may optionally be modified to include drivers for dissimilar hardware if the bare metal restore will be performed on new or dissimilar hardware in server 310. The backup image 325 may also include an IO proxy driver 365 similar to the proxy driver described with respect to FIG. 1. In contrast to the previous embodiment (described in FIG. 1) the proxy driver 365 will not be activated until the operating system is fully booted via iSCSI. It is only after the operating system is booted that the I/O proxy driver is activated. In case of the iSCSI approach, the operating system will transparently retrieve data blocks via the iSCSI. When active, the I/O proxy driver verifies if the block that was requested by operating system is present on the local storage, and if it is present returns the data block from the local storage to the requestor. Otherwise, the proxy driver allows the operating system to proceed with retrieving the data block via iSCSI and when the block gets retrieved it: 1) copies/restores the data block to local storage device, 2) updates the bitmap of restored blocks, and 3) returns data to requestor

One difference between system 300 and system 100 is that an I/O proxy driver 365 now will run inside an operating system 367 as opposed outside the virtual machine 110 and the I/O proxy driver will not be responsible for data retrieval (the data retrieval will be performed by the operating system itself via iSCSI.) The proxy driver may not be not active until the operating system is fully loaded.

On the backup server 315 the backup image 125 is exposed via a proprietary file system (FS) filter driver 330 as a virtual hard disk (VHD) file 335 which in turn gets exported as an iSCSI target device using, for example, Microsoft iSCSI target service 340, which is a standard component of Windows 2008, as a target boot device 345. In one embodiment, the backup image is simply exposed as an iSCSI target disk 345 via a network connection 350, such as local area network or wide area network.

On the server 310 being restored, an iSCSI HBA card 355 or any other means that allow the server 310 to boot hardware via an iSCSI protocol, the server 310 is booted from the iSCSI target device 345 exposed on the server side at 360 as iSCSI initiator. The operating system image being loaded is modified to contain proxy I/O driver 365 which intercepts all I/O requests after the operating system is fully loaded.

An operating system may be loaded via iSCSI and starts executing directly on hardware. The operating system is accessing blocks from boot disk, iSCSI target 345. After server boots successfully, the I/O proxy driver gets activated. Note that the I/O proxy driver is not active while the operating system boots via iSCSI. Then each I/O operation gets intercepted by the I/O proxy driver 365 which examines whether the block was previously requested/restored. The driver 365 may use a bitmap of restored blocks. If the block was previously restored the requested block, in the case of a read operation, will be returned to the requestor directly from local storage. If the block is missing then the block is first read from iSCSI target by the operating system, then the block is saved by the I/O proxy driver to local storage 370, the bitmap is updated and the block is returned to the requestor at 375. In case of write operation blocks get saved by the I/O proxy driver directly to local storage and the bitmap gets updated. At the same time, the server 310 which is being restored provides services at 375.

A background helper process may be run inside the operating system to access blocks not yet accessed by the OS to expedite rehydration/restore process as is also done in system 100.

In essence, a backup image is run on the server 310 being restored and data from the remote backup image is used to gradually rehydrate and restore data to local storage. User's requests get served directly from the server being restored at the same time while BMR is in progress.

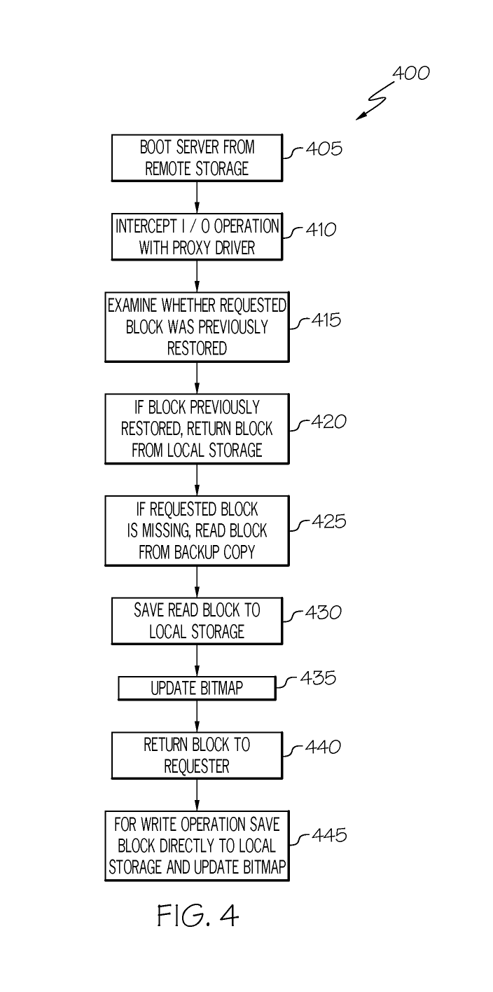

The I/O proxy driver 365 as indicated above intercepts I/O requests and executes a method described at 400 in flowchart form in FIG. 4. Following booting of the server 310 hardware from remote storage at 405. Each IO operation then gets intercepted at 410 by IO proxy driver 365 which examines at 415 whether a requested block was previously requested/restored (for this driver uses bitmap of restored blocks.) If the block was previously restored the requested block (in case of read operation) will be returned at 420 to requestor directly from local storage 370. If the requested block is missing then the block is first read by the operating system via iSCSI at 425 from the remote boot device, target boot device 345. Once the requested block is read, it is saved at 430 to local storage 370. At 435, the bitmap (similar to bitmap 140 in FIG. 1) is updated and the requested block is returned at 440 to the requestor. In case of write operations, blocks are saved at 445 directly to local storage 370, and the bitmap may be updated.

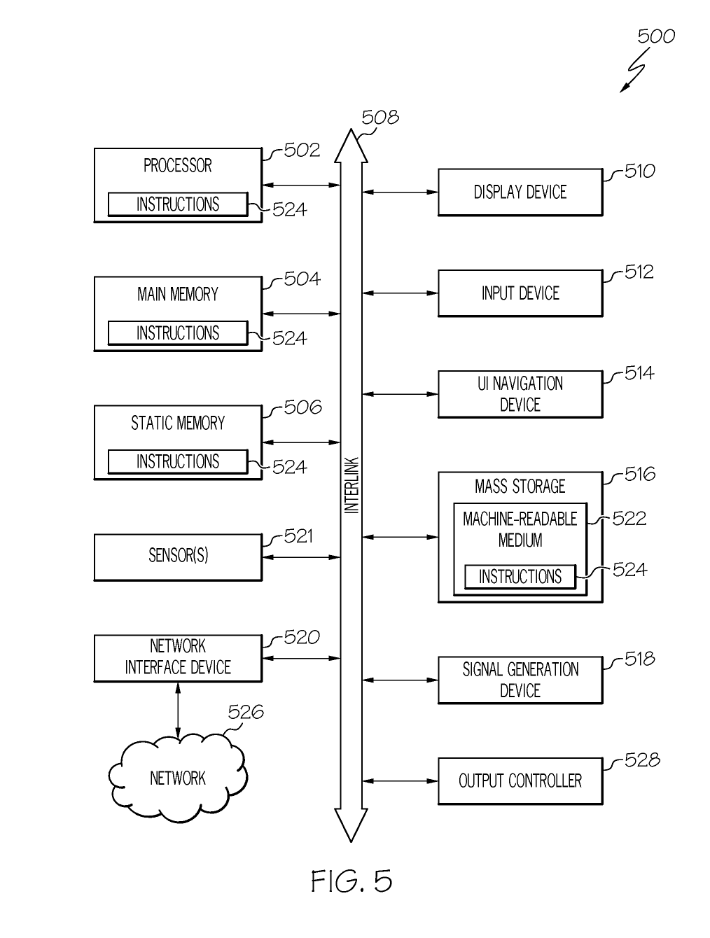

FIG. 5 illustrates a block diagram of an example machine 500 upon which any one or more of the techniques (e.g., methodologies) discussed herein may perform. In particular, the machine 500 may be subjected to the bare metal recovery described herein and may host the virtual machine to respond to user requests during the bare metal recovery process to avoid loss of service for end users. In alternative embodiments, the machine 500 may operate as a standalone device or may be connected (e.g., networked) to other machines. In a networked deployment, the machine 500 may operate in the capacity of a server machine, a client machine, or both in server-client network environments. While only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, also referred to as a network interface card 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having resting mass. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

The flowchart(s) and block diagram(s) in the FIGS. illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the FIGS. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

### EXAMPLES

1. A method comprising:

running a backup image of a device on the device while the device is being restored such that the device being restored is capable of responding to user requests directed to the device being restored;

detecting if data requested by the image being executed is present on local storage and if not, retrieving the data from the backup image residing on a remote server, and restoring the retrieved data to the local storage; and

returning the data requested directly from the local storage to the image being executed.

2. The method of example 1 and further comprising receiving the data in the data request from the local storage of the device being restored once the data is stored on the local storage of the device being restored.

3. The method of any of examples 1-2 and further comprising performing a bare metal recovery of the device being restored.

4. The method of any of examples 1-3 and further comprising booting the device being restored from a backup image into a virtual machine running on the device being restored.

5. The method of example 4 wherein the backup image is run on the virtual machine on the device being restored and uses a pseudo block device driver to check the local storage and cause the data in the data request to be stored in the local storage.

6. The method of example 5 wherein requests for data from the device being restored are directed to the pseudo block device driver which acts as a proxy to the device being restored.

7. The method of any of examples 1-6 wherein determining if the data in the data request is in local storage comprises checking a bitmap representative of blocks of data already stored in the local storage wherein the requested data is in an identified block of data.

8. The method of any of examples 1-7 and further comprising:

determining that all blocks being restored have been restored to local storage such that the system has been restored; and

stopping the virtual machine.

9. The method of example 8 and further comprising:

installing drivers into an operating system of the restored system; and

rebooting the restored system from local storage into the operating system.

10. The method of any of examples 1-9 wherein the backup image is obtained from a remote bootable storage device.

11. The method of example 10 wherein the remote bootable storage device is coupled to the device via an iSCSI over network connection.

12. The method of any of examples 1-11 wherein the backup image is booted from a remote iSCSI device and run directly on device being restored

13. A system to be restored comprising:

a local storage device; and

a processor, the processor programmed to:

run a backup image of a device on the device while the system is being restored such that the system being restored is capable of responding to user requests directed to the system being restored;

detect if data requested by the image being executed is present on local storage and if not, retrieving the data from the backup image residing on a remote server, and restoring the retrieved data to the local storage; and

return the data requested directly from the local storage to the image being executed.

14. The system of example 13 wherein the processor is further programmed to receive the data in the data request from the local storage of the system being restored once the data is stored on the local storage of the system being restored.

15. The system of any of examples 13-14 wherein the processor is further programmed to cause the processor to use a pseudo block device to check the local storage and cause the data to be stored in the local storage.

16. The system of any of examples 13-15 wherein the request for data is generated by an operating system running on the processor and booted via the backup image which is remote from the system.

17. The system of any of examples 13-16 wherein the processor is further programmed to determine if the data requested is in local storage by checking a bit map representative of blocks of data already stored in the local storage wherein the data requested is in an identified block of data.

18. The system of any of examples 13-17 wherein the processor is further programmed to:

determine that all blocks being restored have been restored to local storage such that the system has been restored; and

stop running the backup image.

19. The system of example 18 wherein the storage device contains code to cause the processor to:

install drivers into an operating system of the restored system; and

reboot the restored system into the operating system via the local storage.

20. A computer program product comprising:

a computer readable storage medium having computer readable program code embodied therewith, the computer program code comprising:

computer readable program code configured to cause a processor to:

run a backup image of a device on the device while the device is being restored such that the device being restored is capable of responding to user requests directed to the device being restored;

detect if data requested by the image being executed is present on local storage and if not, retrieving the data from the backup image residing on a remote server, and restoring the retrieved data to the local storage; and

return the data requested directly from the local storage to the image being executed.

21. The computer program product of example 20 wherein the computer readable program code configured to receive the data requested from the local storage of the device being restored once the requested data is stored on the local storage of the device being restored.

22. The computer program product of any of examples 20-21 wherein the computer readable program code is configured to use a pseudo block device to check the local storage and cause the data requested to be stored in the local storage.

23. The computer program product of any of examples 20-22 wherein requests for data from the device being restored are directed to a remote server containing the backup image.

24. The computer program product of any of examples 20-23 wherein the backup image resides in a virtual machine running on the device to be restored.

25. The computer program product of any of examples 20-24 wherein the backup image resides on a remote storage device from which the device being restored is bootable.

26. A method comprising:

running a virtual machine on a device being restored, the virtual machine to respond to user requests directed to the device being restored;

receiving a request for data;

determining if the requested data is available from local storage of the device being restored; and

causing the requested data to be stored in the local storage of the device being restored from a backup storage if the storage of the device being restored does not yet have the requested data.

27. A system comprising:

a processor of a device to be restored, the processor programmed to:

run a virtual machine on the device being restored, the virtual machine to respond to user requests directed to the device being restored;

receive a request for data, the request directed to the device being restored via bare metal recovery;

determine if the requested data is available from local storage of the device being restored; and

cause the requested data to be retrieved from a backup storage and stored in the local storage of the device being restored if the storage of the device being restored does not yet have the requested data.

28. A computer program product comprising:

a computer readable storage medium having computer readable program code embodied therewith, the computer program code comprising:

computer readable program code configured to:

run a virtual machine on a device being restored from bare metal, the virtual machine to respond to user requests directed to the device being restored;

receive a request for data, the request directed to the device being restored;

determine if the requested data is available from local storage of the device being restored; and

cause the requested data to be retrieved from a backup storage and stored in the local storage of the device being restored if the storage of the device being restored does not yet have the requested data.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method comprising:
running a backup image of a device on the device while the device is being restored such that the device being restored is capable of responding to user requests directed to the device being restored;
detecting if data requested by the image being executed is present on local storage and if not, retrieving the data from the backup image residing on a remote server, and restoring the retrieved data to the local storage; and
returning the data requested to the image being executed.

2. The method of claim 1 and further comprising receiving the data in the data request from the local storage of the device being restored once the data is stored on the local storage of the device being restored.

3. The method of claim 1 and further comprising performing a bare metal recovery of the device being restored.

4. The method of claim 1 and further comprising booting the device being restored from a backup image into a virtual machine running on the device being restored.

5. The method of claim 4 wherein the backup image is run on the virtual machine on the device being restored and uses a pseudo block device driver to check the local storage and cause the data in the data request to be stored in the local storage.

6. The method of claim 5 wherein requests for data from the device being restored are directed to the pseudo block device driver which acts as a proxy to the device being restored.

7. The method of claim 1 wherein determining if the data in the data request is in local storage comprises checking a bitmap representative of blocks of data already stored in the local storage wherein the requested data is in an identified block of data.

8. The method of claim 1 and further comprising:
determining that all blocks being restored have been restored to local storage such that the system has been restored; and
stopping the virtual machine.

9. The method of claim 8 and further comprising:
installing drivers into an operating system of the restored system; and
rebooting the restored system from local storage into the operating system.

10. The method of claim 1 wherein the backup image is obtained from a remote bootable storage device.

11. The method of claim 10 wherein the remote bootable storage device is coupled to the device via an iSCSI over network connection.

12. The method of claim 1 wherein the backup image is booted from a remote iSCSI device and run directly on device being restored.

13. A system to be restored comprising:
a local storage device; and
a processor, the processor programmed to:
run a backup image of a device on the device while the system is being restored such that the system being restored is capable of responding to user requests directed to the system being restored;
detect if data requested by the image being executed is present on local storage and if not, retrieving the data from the backup image residing on a remote server, and restoring the retrieved data to the local storage; and
return the data requested to the image being executed.

14. The system of claim 13 wherein the processor is further programmed to receive the data in the data request from the local storage of the system being restored once the data is stored on the local storage of the system being restored.

15. The system of claim 13 wherein the processor is further programmed to cause the processor to use a pseudo block device to check the local storage and cause the data to be stored in the local storage.

16. The system of claim 13 wherein the request for data is generated by an operating system running on the processor and booted via the backup image which is remote from the system.

17. The system of claim 13 wherein the processor is further programmed to determine if the data requested is in local storage by checking a bit map representative of blocks of data already stored in the local storage wherein the data requested is in an identified block of data.

18. The system of claim 13 wherein the processor is further programmed to:
determine that all blocks being restored have been restored to local storage such that the system has been restored; and
stop running the backup image.

19. The system of claim 18 wherein the storage device contains code to cause the processor to:
install drivers into an operating system of the restored system; and
reboot the restored system into the operating system via the local storage.

20. A computer program product comprising:
a computer readable storage medium having computer readable program code embodied therewith, the computer program code comprising:
computer readable program code configured to cause a processor to:
run a backup image of a device on the device while the device is being restored such that the device being restored is capable of responding to user requests directed to the device being restored;
detect if data requested by the image being executed is present on local storage and if not, retrieving the data from the backup image residing on a remote server, and restoring the retrieved data to the local storage; and
return the data requested to the image being executed.

21. The computer program product of claim 20 wherein the computer readable program code configured to receive the data requested from the local storage of the device being restored once the requested data is stored on the local storage of the device being restored.

22. The computer program product of claim 20 wherein the computer readable program code is configured to use a pseudo block device to check the local storage and cause the data requested to be stored in the local storage.

23. The computer program product of claim 20 wherein requests for data from the device being restored are directed to a remote server containing the backup image.

24. The computer program product of claim 20 wherein the backup image resides in a virtual machine running on the device to be restored.

25. The computer program product of claim 20 wherein the backup image resides on a remote storage device from which the device being restored is bootable.
